(19) United States
(12) Patent Application Publication
(10) Pub. No.: US 2010/0055340 A1
(43) Pub. Date: Mar. 4, 2010

(54) Method for Coating Core Ceramic Particles by Emulsion Flame Spray Pyrolysis

(75) Inventors: Seung Bin Park, Daejeon (KR); Shin Ae Song, Seoul (KR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: KOREA ADVANCED INSTITUTE OF SCIENCE AND TECHNOLOGY, Daejeon (KR)

(21) Appl. No.: 12/549,477

(22) Filed: Aug. 28, 2009

(30) Foreign Application Priority Data
Aug. 28, 2008 (KR) 1020080084503

(51) Int. Cl. C23C 4/04; B05D 1/08; C23C 4/10

(52) U.S. Cl. 427/452; 427/446; 427/453

(57) ABSTRACT

A method for coating the core ceramic particles by emulsion flame spray is provided. In particular, the method forms a core ceramic particle simultaneously with coating the surface of the formed core ceramic particles by emulsion flame spray pyrolysis. The core ceramic particle may be coated in a single stage by emulsion flame spray pyrolysis conventionally used in the art, through putting coating material precursor into the oil phase of emulsion solution at a stage of preparing emulsion solution in emulsion flame spray pyrolysis process.

### CROSS-REFERENCE TO RELATED APPLICATIONS

This application claims priority to foreign Patent Application KR 10-2008-84503, filed on Aug. 28, 2008, the disclosure of which is incorporated herein by reference in its entirety.

### FIELD OF THE INVENTION

The present invention relates to a method for coating core ceramic particles by emulsion flame spray pyrolysis, and more particularly, to a method for forming a core ceramic particle simultaneously with coating of the surface of the formed core ceramic particle in a single stage by emulsion flame spray pyrolysis.

### BACKGROUND OF THE INVENTION

As a conventional method for coating ceramic particles, liquid phase deposition is well known, which includes two stages of preparing ceramic particles to form a core and mixing the ceramic particles in a precursor coating solution so as to coat the surface of the ceramic particles with other ceramic materials. More particularly, the liquid phase deposition is performed by preparing ceramic particles; liquid phase precipitating; filtering; washing; drying or calcining; and milling the resultant material, in sequential order. The ceramic particles are first prepared and then put into a solution containing a reactant material to allow a chemical reaction on the surface of the prepared core ceramic particles. After completion of the chemical reaction, the coated ceramic particles are treated by further processes such as filtering, washing and drying or calcining, so as to obtain a powder product. Afterward, milling process for the product is performed to split an aggregate into small particles having desired sizes. However, such liquid phase deposition has disadvantages such as complexity in process and deteriorated quality of the coated particle. The liquid phase deposition including two separate stages of preparing ceramic particles and coating the prepared ceramic particles has encountered problems of extended process and increased preparation costs.

Conventional technologies with respect of the present invention have been disclosed. For instance, Korean Patent Laid-Open No. 10-2007-97019 describes a powder coating method using a supercritical fluid. The supercritical fluid is used to dissolve a coating material precursor and the prepared precursor solution is sprayed over powders. Therefore, the above coating method includes individual processes of preparing particles and coating the prepared particles. Korean Patent Laid-Open No. 10-2007-50655 describes a nanoparticle coating method as an improved modification of the liquid phase deposition, characterized in that the surface of the nanoparticle is substituted by an organic substance having a hydrophilic substituent and the nanoparticle as well as a coating material precursor are added to an organic solvent containing an amphiphilic surfactant so as to coat the nanoparticle.

Some documents regarding the aforementioned technologies have been disclosed and, for example, M. Alonso, et al., Atmospheric Research 82, p. 605, 2006 proposed use of a vapor phase such that zinc chloride vapor passes over the surface of salt to coat the same. In particular, the coating process is performed by preparing core particles, placing the prepared core particles in a furnace and passing a gaseous coating material around the core particles.

G. T. Fey et al., Solid State Ionics, 176, p. 2759, 2005 suggested a liquid phase deposition method in that LiNiO.8CoO.2O₂ powder is immersed in an aqueous solution of La(NO₃), followed by drying and heating the powder to prepare a La₂O₃ coated LiNiO.8CoO.2O₂. More particularly, the above method includes two stages of preparing a core particle, then, immersing the core particle in a coating material precursor solution or passing a gaseous coating material over the surface of the core particle to coat the core particle.

These methods include two separate stages of preparing ceramic particles and coating the prepared ceramic particles also have problems such as extended preparation time and increased preparation costs.

### SUMMARY OF THE INVENTION

Embodiments of the present invention advantageously provide a method comprising placing a coating material precursor in an oil phase during preparation of an emulsion solution; forming a core ceramic particle simultaneously with coating of the surface of the formed core ceramic particle by emulsion flame spray pyrolysis.

Another embodiment of the present invention provides a method for preparing coated ceramic particles in a single stage by a simple and short process, so as to reduce preparation costs thereof.

A further embodiment of the present invention provides a method for coating core ceramic particles by emulsion flame spray pyrolysis.

The method for coating core ceramic particles comprises preparing an emulsion solution; spraying the emulsion solution to flame; and forming a core ceramic particle and, at the same time, coating the surface of the formed core ceramic particle.

Another embodiment of the present invention provides a method comprising putting coating material precursor into an oil phase during preparation of an emulsion solution and forming the core ceramic particle simultaneously with coating of the surface of the formed core ceramic particle by emulsion flame spray pyrolysis, thereby shortening preparation time and reducing preparation costs.

### BRIEF DESCRIPTION OF THE DRAWINGS

These and other features, aspects, and advantages of the present invention will be more fully described in the following detailed description of preferred embodiments and examples, taken in conjunction with the accompanying drawings. In the drawings:

FIG. 1 shows a preparation mechanism of a core ceramic particle coated by emulsion flame spray pyrolysis;

FIG. 2 shows an apparatus for emulsion flame spray pyrolysis used in an exemplary embodiment of the present invention;

FIG. 3 is a TEM photograph showing a ZrO₂ coated NiO core ceramic particle according to Example 2 of the present invention;

FIG. 4 is a TEM photograph showing a SiO₂ coated CeO₂ core ceramic particle according to Example 3 of the present invention;

FIG. 5 is a TEM photograph showing a ZrO₂ coated CoFe₂O₄ core ceramic particle according to Example 4 of the present invention; and

FIG. 6 is a TEM photograph showing an uncoated NiO core ceramic particle according to Comparative Example in the disclosure.

### DETAILED DESCRIPTION

The invention will now be described with reference to the drawing figures, in which like reference numerals refer to like parts throughout.

Embodiments of the present invention provide a method for coating a core ceramic particle by emulsion flame spray pyrolysis.

The method for coating a core ceramic particle by emulsion flame spray pyrolysis comprises: preparing an emulsion solution; spraying the emulsion solution to flame; and forming a core ceramic particle and, at the same time, coating the surface of the formed core ceramic particle.

The emulsion solution includes an oil phase containing a coating material precursor and a water phase containing a core material precursor. Spraying the emulsion solution to pass through the flame may form the core ceramic particle and, at the same time, may coat the surface of the formed core ceramic particle.

The coating material precursor may include at least one metal oxide selected from a group consisting of silica, alumina, titania, yttria, zirconia, ceria, gallium oxide, lanthanum oxide, iron oxide, nickel oxide, cobalt oxide, copper oxide and zinc oxide.

The core material precursor may include: at least one single metal oxide selected from a group consisting of silica, zirconia, titania, yttria, ceria, alumina, nickel oxide, cobalt oxide, iron oxide, copper oxide and zinc oxide; or a composite metal oxide comprising at least one or two metals selected from a group consisting of aluminum, silicon, titanium, chromium, manganese, nickel, iron, cobalt, copper, zinc, yttrium, zirconium, strontium, barium, cerium, gallium, indium, tin, calcium, magnesium, sodium and lanthanum.

Hereinafter, the present invention will be described in more detail.

The present invention provides a method for preparation of coated ceramic particles in a single stage by emulsion flame spray pyrolysis.

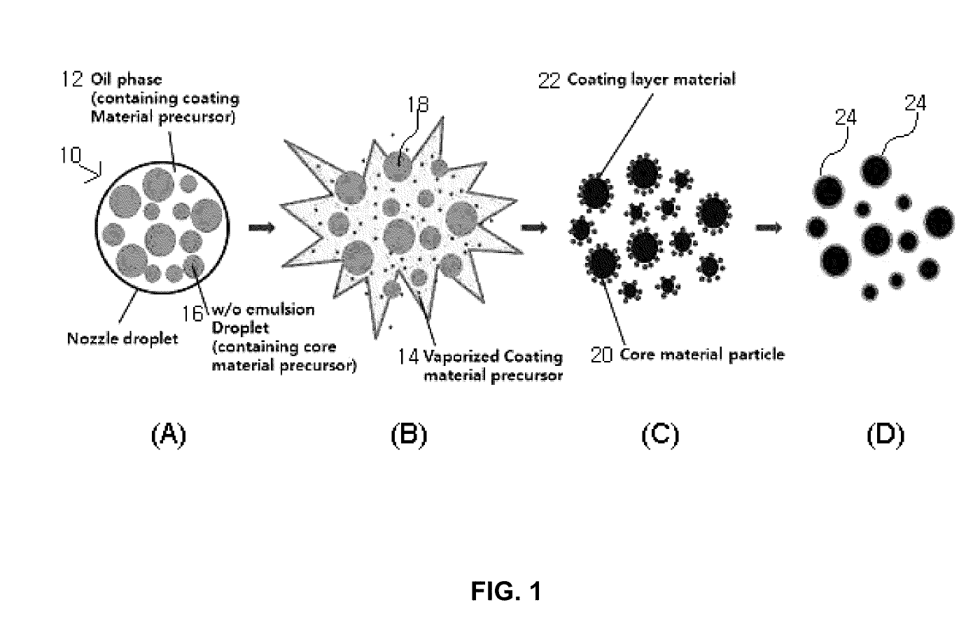

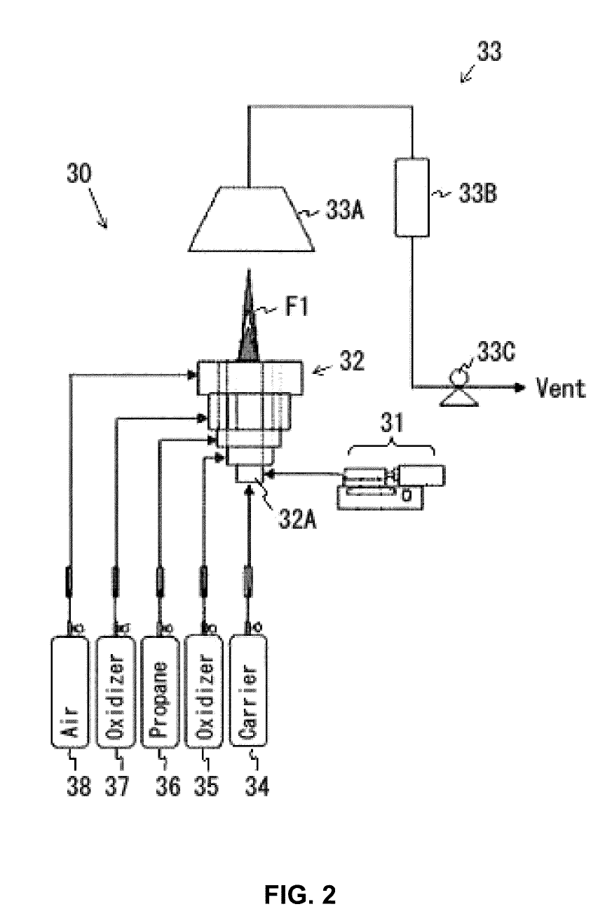

First, as shown in FIG. 1(A), a coating material precursor (14) and a dispersant are put into an oil phase (12) of the emulsion solution (10) while a core ceramic material precursor (18) is put into a water phase (16) of the emulsion solution (10). The two phases are blended to prepare an emulsion solution (10). Then, the prepared emulsion (10) is sprayed to flame via the droplet generation device (32A) (See FIG. 2), wherein an emulsion droplet in the nozzle includes several water droplets. When the emulsion droplet is injected into the flame, the water droplets may form core ceramic particles (20) through drying, decomposing and crystallizing processes, as shown in FIG. 1(B) and FIG. 1(C). At the same time, the coating material precursor (14) contained in the oil phase (12) of the emulsion droplet is vaporized as shown in FIG. 1(B) by a high temperature of the flame, then, is subjected to nucleation and crystal growth as a coating layer material (22) on the surface of the formed core ceramic particle (20). As a result, the core ceramic particle (24) coated by the coating layer material is obtained, as shown in FIG. 1(D). FIG. 1 is a schematic showing mechanism of the core ceramic particle coated by emulsion flame spray pyrolysis.

Conventionally, coating of a core ceramic particle is performed by two stages of preparing the core ceramic particle and coating the prepared core ceramic particle with other ceramic materials. However, the present invention adopts only a single stage to prepare surface-coated core ceramic particles.

Hereinafter, preferred embodiments of the present invention will be described in detail in the following example and experimental example which are given for illustrative purposes only and should not be construed as limiting the spirit and scope of the present invention.

### Example 1

An apparatus for emulsion flame spray pyrolysis (30) generally comprises a droplet generation device (32A), a flame nozzle (32), and a particle collector (33). FIG. 2 shows the schematic of the apparatus for emulsion flame spray pyrolysis (30).

Herein, the syringe pump (31) is used to supply emulsion solution. The flame nozzle (32) is connected to the droplet generation device (32A) that introduces the droplet by the carrier gas from a carrier tank (34). And the flame nozzle (32) is connected to O₂ gas sources (35, 37) that introduce O₂ gas, a propane gas source (36) that introduce propane gas, and an air source (38) that introduce air. Therefore, when the droplet is introduced into the flame nozzle (32) through the droplet generation device (32A), O₂ from the O₂ gas sources (35,37), propane gas from the propane gas source (36), and air from the air source (38) are introduced together into the flame nozzle (32), such that the combustion is made in the flame nozzle (32) to generate flame (F1). In addition, the particle collector (33) includes the bag filter (33B), wherein a feed part (33A) and air pump (33C) are each disposed before and after the bag filter (33B).

An emulsion solution was converted into emulsion droplets in several tens micrometer scale by the droplet generation device (32A) of the apparatus for emulsion flame spray pyrolysis (30). And the emulsion droplets flowed into the flame (F1) by the carrier gas from the carrier tank (34). In the flame (F1) maintained at a high temperature by combustion of propane gas, the emulsion droplets were converted into core ceramic particles through drying, decomposing, reacting and crystallizing processes. In this case, each emulsion droplet formed only one core ceramic particle. A coating material precursor contained in an oil phase of the emulsion droplet was vaporized by the high temperature of the flame (F1), then, was subjected to nucleation and crystal growth on the surface of the formed core ceramic particle. As a result, the surface-coated core ceramic particle was obtained. Such surface-coated core ceramic particles were captured by the bag filter (33B).

### Example 2

### ZrO₂ Coated NiO Core Ceramic Particle

In this Example 2, Zirconia (ZrO₂) coated NiO core ceramic particles are prepared.

In general, a solid oxide fuel cell (often referred to as ‘SOFC’) has NiO as an anode and ZrO₂ as an electrolyte. If the surface of the NiO anode is coated with the ZrO₂ electrolyte, adhesion between the anode and the electrolyte is improved which in turn enhances performance of the SOFC.

The emulsion solution is prepared as follows: firstly, a core material precursor, that is, nickel nitrate hexahydrate was dissolved in water to prepare 30 ml of 1M metal aqueous solution. Next, 3.75 g of span80 (Sorbitan monooleate) and a small amount of zirconyl acetylacetonate as a coating material precursor were dissolved in 100 ml of toluene, followed by adding to the 1M metal aqueous solution so as to prepare mixture. Then, the mixture was subjected to sonication using a sonicator for 2 minutes to prepare the emulsion solution. The obtained emulsion solution was converted into droplets in micrometer scale by the droplet generation device (32A) and the droplets were dispersed in the air. At this time, each droplet generated by the droplet generation device (32A) includes several emulsion droplets. The emulsion droplets flowed into the flame (F1) together with a carrier gas. In the flame (F1), oil fraction in the droplets was burnt off by flame and the coating material precursor in the oil fraction was vaporized. The flame was generated by providing oxygen from the O₂ gas source (35) at 10 L/min, a propane gas from the propane gas source (36) at 0.7 L/min, oxygen from another O₂ gas source (37) at 10 L/min and air from the air source (38) at 20 L/min, respectively.

After evaporating water fraction of the droplets, each emulsion droplet formed a core ceramic particle through drying, decomposing, reacting and crystallizing processes. After formation of the core ceramic particle, the vaporized coating material around the core ceramic particle was subjected to nucleation and crystal growth on the surface of the core ceramic particle, thereby coating the core ceramic particle. Such surface-coated core ceramic particles were then captured and recovered by the bag filter (33B). In order to enhance crystallinity of the recovered ZrO₂ coated NiO core ceramic particle, heat treatment for the core ceramic particle was performed at 700° C. for 3 hours.

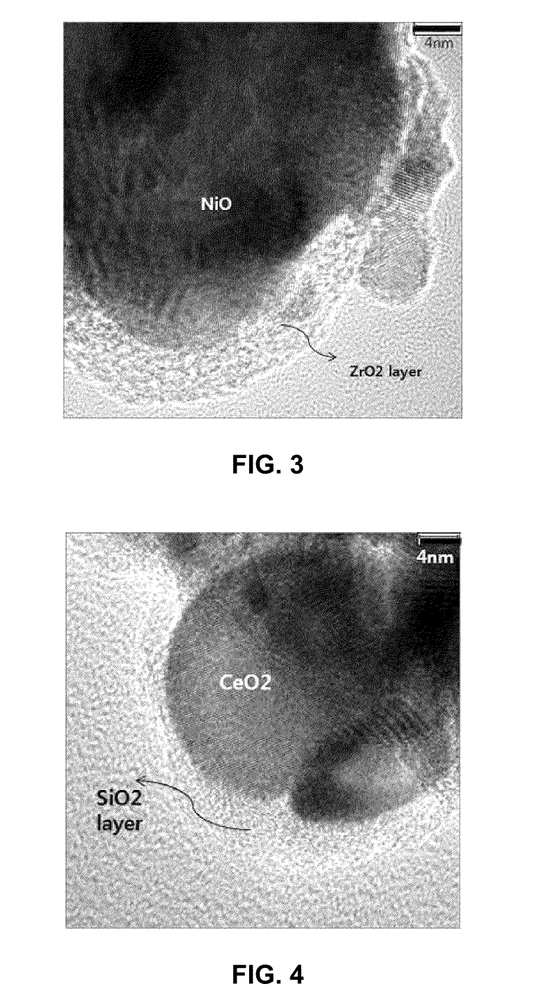

FIG. 3 shows a TEM photograph of the ZrO₂ coated NiO core ceramic particle according to Example 2 described above.

### EXAMPLE 3

### SiO₂ Coated CeO₂ Core Ceramic Particle

In this Example 3, SiO₂ coated CeO₂ core ceramic particles are prepared. The CeO₂ is generally used as an abrasive for CMP slurry and, if the surface of CeO₂ is coated with SiO₂, this material may exhibit more improved dispersion properties in water.

Such SiO₂ coated CeO₂ core ceramic particles were prepared according to the same procedure as described in Example 2, except that the core material precursor is cerium nitrate hexahydrate and the coating material precursor is polysiloxane. In addition, the flame was generated by proving oxygen from the O₂ gas source (35) at 15 L/min, a propane gas from the propane gas source (36) at 0.4 L/min, oxygen from another O₂ gas source (37) at 15 L/min and air from the air source (38) at 20 L/min, respectively.

In order to enhance crystallinity of the recovered SiO₂ coated CeO₂ core ceramic particle, heat treatment for the core ceramic particle was performed at 700° C. for 3 hours.

FIG. 4 shows a TEM photograph of the SiO₂ coated CeO₂ core ceramic particle according to Example 3 described above.

### EXAMPLE 4

### Si₂ Coated CoFe₂O₄ Core Ceramic Particle

In this Example 4, SiO₂ coated CoFe₂O₄ core ceramic particles are prepared. CoFe₂O₄ is known to have magnetic properties.

The SiO₂ coated CoFe₂O₄ core ceramic particles were prepared according to the same procedure as described in Example 2, except that the core material precursor is cobalt nitrate hexahydrate and iron nitrate nonahydrate while the coating material precursor is tatra-ethyl-ortho-silicate (TEOS). In addition, the flame was generated by providing oxygen from the O₂ gas source (35) at 15 L/min, a propane gas from the propane gas source (36) at 0.4 L/min, oxygen from another O₂ gas source (37) at 15 L/min and air from the air source (38) at 20 L/min, respectively.

In order to enhance crystallinity of the recovered SiO₂ coated CoFe₂O₄ core ceramic particle, heat treatment for the core ceramic particle was performed at 800° C. for 3 hours.

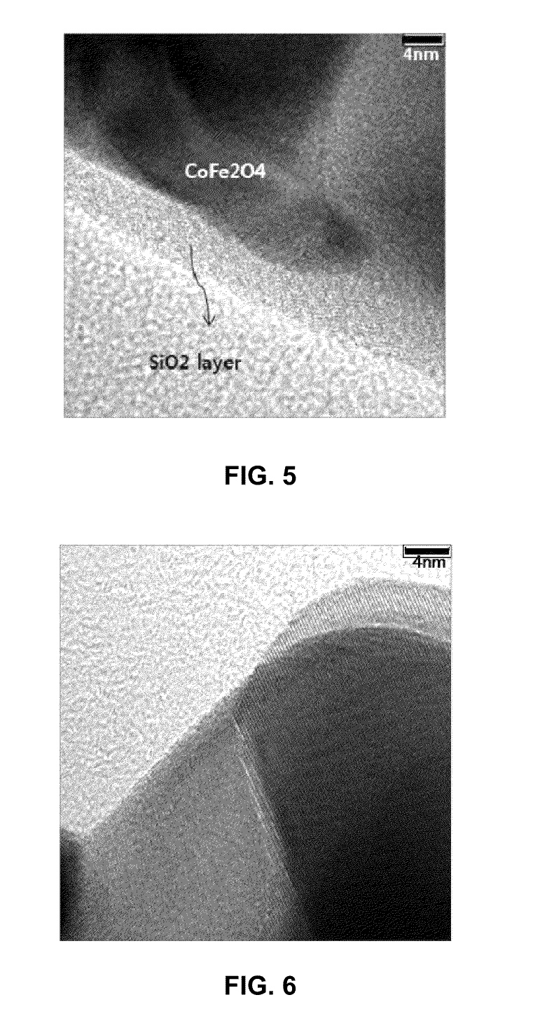

FIG. 5 shows a TEM photograph of the SiO₂ coated CoFe₂O₄ core ceramic particle according to Example 4 described above.

### COMPARATIVE EXAMPLE

### NiO Core Ceramic Particle

For comparison with the ZrO₂ coated NiO core ceramic particles in Example 2, uncoated NiO core ceramic particles are prepared in this Comparative Example.

The uncoated NiO core ceramic particles were prepared according to the same procedure as described Example 2, except that any coating material precursor is not added.

FIG. 6 shows a TEM photograph of the NiO core ceramic particle according to Comparative Example described above.

According to the present invention, emulsion flame spray pyrolysis was performed after feeding the coating material precursor into the oil phase during preparation of the emulsion solution. Consequently, preparation of the core ceramic particle and coating of the surface of the prepared core ceramic particle are substantially carried out in a single stage so that the present invention may shorten preparation time while reducing preparation costs, thereby being efficiently employed industrial applications.

While the present invention has been described with reference to preferred embodiments, it will be understood by those skilled in the art that various modifications and variations may be made therein without departing from the spirit and scope of the present invention as defined by the appended claims.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A method for coating a core ceramic particle by emulsion flame spray pyrolysis, comprising:
preparing an emulsion solution;
spraying the emulsion solution to flame; and
forming a core ceramic particle simultaneously with coating of the surface of the formed core ceramic particle, after the spraying process.

2. The method according to claim 1, wherein the emulsion solution includes an oil phase containing a coating material precursor and a water phase containing a core material precursor.

3. The method according to claim 2, wherein the coating material precursor is at least one metal oxide selected from a group consisting of silica, alumina, titania, yttria, zirconia, ceria, gallium oxide, lanthanum oxide, iron oxide, nickel oxide, cobalt oxide, copper oxide and zinc oxide.

4. The method according to claim 2, wherein the core material precursor is at least one single metal oxide selected from a group consisting of silica, zirconia, titania, yttria, ceria, alumina, nickel oxide, cobalt oxide, iron oxide, copper oxide and zinc oxide, or a composite metal oxide comprising at least one or two metals selected from a group consisting of aluminum, silicon, titanium, chromium, manganese, nickel, iron, cobalt, copper, zinc, yttrium, zirconium, strontium, barium, cerium, gallium, indium, tin, calcium, magnesium, sodium and lanthanum.
